(19) United States
(12) Patent Application Publication
(10) Pub. No.: US 2010/0012302 A1
(43) Pub. Date: Jan. 21, 2010

(54) DUAL ROW HEAT EXCHANGER AND AUTOMOBILE BUMPER INCORPORATING THE SAME

(75) Inventors: Denis Clodic, Paris (FR); Youssef Riachi, Paris (FR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington (DE)

(21) Appl. No.: 12/518,711

(22) PCT Filed: Dec. 17, 2007
(86) PCT No.: PCT/US07/25675

§ 371 Date: Jun. 11, 2009

Related U.S. Application Data
(60) Provisional application No. 60/875,982, filed on Dec. 19, 2006.

(51) Int. Cl. F28D 1/00; B60R 19/02

(52) U.S. Cl. 165/144; 293/113

(57) ABSTRACT

A heat exchanger has a cross-current/counter-current structure, so that air which is directed across the heat exchanger is heated in the two successive rows. This design takes advantage of the temperature glide of a refrigerant blend. In this design, the hottest refrigerant blend is in contact with the hottest air, and the coldest refrigerant blend is in contact with the coldest air, leading to a lower difference between the average refrigerant blend temperature and the average air temperature compared to a pure refrigerant in a one-row heat exchanger.

### BACKGROUND OF THE INVENTION

1. Field of the Invention

The present invention relates to heat exchangers, such as condensers and evaporators, for circulating a heat transfer fluid. In particular, the present invention relates to a unique design for a heat exchanger which may be used in an automobile.

2. Description of Related Art

The refrigeration industry has been working for the past few decades to find replacement refrigerants for the ozone depleting chlorofluorocarbons (CFC's) and hydrochlorofluorocarbons (HCFC's) being phased out as a result of the Montreal Protocol. The solution for most refrigerant producers has been the commercialization of hydrofluorocarbon (HFC) refrigerants. The new HFC refrigerants, HFC-134a being the most widely used at this time, have zero ozone depletion potential and thus are not affected by the current regulatory phase out as a result of the Montreal Protocol.

Further environmental regulations may ultimately cause global phase out of certain HFC refrigerants. Currently, the automobile industry is facing regulations relating to global warming potential (GWP) for refrigerants used in mobile air-conditioning. Therefore, there is a great current need to identify new refrigerants with reduced global warming potential for the automobile air-conditioning market. Should the regulations be more broadly applied in the future, an even greater need will be felt for refrigerants that can be used in all areas of the refrigeration and air-conditioning industry.

Currently proposed replacement refrigerants for HFC-134a include HFC-152a, pure hydrocarbons such as butane or propane, or “natural” refrigerants such as CO₂ or ammonia. Many of these suggested replacements are toxic, flammable, and/or have low energy efficiency. Therefore, new alternatives are constantly being sought, some of which may be blends in order to reduce, e.g., toxicity or flammability, or increase energy efficiency.

Pure refrigerants do not exhibit temperature glide during condensation and evaporation. However, refrigerant blends may show a temperature glide of several degrees Kelvin (° K.) during their condensation and evaporation cycles. FIG. 1 is the temperature/entropy diagram of a refrigerant blend having a temperature glide (ΔT_{cond}). The temperature evolutions at the condenser side are represented by the following segments: C-D is the de-superheating of the refrigerant blend, D-F is the condensation with a temperature glide, and F-G is sub-cooling. E is an intermediate point during the condensation, which occurs between D and F.

As shown on the y-axis the temperature difference ΔT_{cond} between D and F varies from 5 to 7° K. Similarly, evaporation, represented by the segment H-A, is also associated with a glide of temperature ΔTₑᵥₐₚ of several degrees Kelvin, typically 5 to 6 OK. The other thermodynamic evolutions shown in FIG. 1 are the segment A-B, representing the superheating of the refrigerant blend at the evaporating pressure, the segment B-C being the compression of the refrigerant blend by the compressor, the segment F-G being the sub-cooling of the refrigerant blend at the end of the condenser, the segment G-H being the expansion of either by a thermo-expansion valve or by an orifice tube. All these evolutions are met in all vapor compression systems using phase change refrigerants.

FIG. 2 shows a temperature/entropy diagram of a pure refrigerant, which illustrates that pure refrigerants do not exhibit temperature glide during condensation and evaporation. In FIG. 2, the evolution D′-F′ for condensation and H′-A′ for evaporation are at constant temperature, and E′ is an intermediate point during the condensation with the same temperature as D and F.

FIG. 3 is a temperature profile for a pure refrigerant that shows the temperature of air, in which the top line is horizontal from F′ to D′. FIG. 4 is a temperature profile for a refrigerant blend, and shows the evolutions D-F and F-G of FIG. 1 for de-superheating, condensation and sub-cooling of the refrigerant blend. Both FIGS. 3 and 4 show the T_{y-z} for a pure refrigerant and T_{w-x} for a refrigerant with a temperature glide as the refrigerant is condensing. As shown in FIGS. 3 and 4, ΔT_{y-z} is larger than ΔT_{w-x} for the same heat exchange surface due to the fact that the glide refrigerant achieves glide matching (as represented by D-F and 11-12 of FIG. 4) and with the air side temperature while the pure refrigerant does not achieve glide matching (as represented by D′-F′ and 11-12 of FIG. 3).

The average thermodynamic temperature, expressed in degrees Kelvin, is calculated by the relationship T_{w}=h_{c}−h_{g}/s_{c}−s_{g}, where h is the enthalpy expressed in kJ/kg, s is the entropy in kJ/kg.K, and the indices represent the points of FIGS. 1 and 4. For a heat exchanger where the refrigerant blend is inside the tube and is cooled by air outside the tube, the average temperature Tₓ can be calculated similarly, Tₓ=h₁₂−h₁₁/s₁₂−s₁₁.

The design of refrigerant-to-air heat exchangers is complex, due to the poor heat exchange properties of air, which has a low heat capacity and a low thermal conductivity. As known in the art, refrigerant-to-air heat exchangers use fin tubes in order to enhance the heat exchange surface on the air side by a factor 10 to 100 compared to the internal surface of the tube where the refrigerant circulates. Air flows in a cross-current manner with respect to refrigerant flow. Such heat exchangers may be either condensers or evaporators.

FIG. 5 shows a typical design of a one-row refrigerant condenser 1′ of the prior art used for condensing refrigerants, which can be either pure refrigerants or blends. Condenser 1′ is composed of four successive passes of multiple fin tubes 2′, 3′, 4′, and 5′. Those tubes are fed in parallel by a refrigerant collector 6′. The refrigerant then flows through the successive passes 3′, 4′, and 5′ via collectors 7′, 8′, and 9′ and exits the condenser through the collector 10′. Air circulates in a cross-flow manner across the condenser as indicated by the arrow going from 11′ to 12′.

For mobile air conditioning applications, a significant complementary advantage is linked to this new design of a two-row condenser as explained hereafter. FIG. 6 shows a front end 15a′ of a bumper 15′ of an automobile, including a known single-row condenser of the prior art. As can be seen from FIG. 7, which also shows the front end of a bumper, the bumper limits the air circulation coming from the outside represented by point a′ in FIG. 7 to the inside of the engine compartment after the condenser at point b′ in FIG. 7. As shown in FIG. 7, the one-row condenser 1′ of the air conditioning system is installed just behind the bumper and in front of the radiator 16′ for cooling the engine 17′. Also one or several fans 18′ are installed behind the condenser 1′ and the radiator 16. The fans draw the necessary air flow for cooling the condenser and the radiator when the vehicle is idling or when the air flow rate entering the engine compartment is not sufficient. The poor air distribution on the condensers is due to the bumper drag, which hampers the heat exchange performance of the condenser of the mobile air conditioning system and thereby increases the condensing pressure and energy consumption.

Although an evaporator may not be adjacent the front end bumper of an automobile, it may still exhibit performance issues when a refrigerant blend is used in the evaporator. FIG. 8 shows a typical design of a known evaporator. The evaporator, shown generally at 19′, designed for pure refrigerant, is composed of four tanks 20′, 21′, 22′, and 23′, composed of plates and fins. The refrigerant enters through the collector 24′, circulates downwards in the tank 20′, then goes successively to tank 23′ through collector 25′, then to tank 22′ through collector 26′, then from to tank 22′ to tank 21′ through collector 27′, and finally exits in vapor phase through collector 28′. The air circulates from point 31′ to point 32′ as indicated by the arrow.

FIGS. 9 and 10 show respectively the variation of air and refrigerant temperatures for a pure refrigerant in FIG. 9 and for refrigerant blends in FIG. 10 having a glide during evaporation in FIG. 10. The air temperature, which has been averaged between the inlet and the outlet, is shown at points 29′ and 30′, respectively, in FIGS. 9 and 10. As can be seen from FIGS. 9 and 10, the average refrigerant evaporating temperature, calculated between points 24′ and 28′ in FIGS. 9 and 10, is larger for a pure refrigerant than for a refrigerant blend.

Efficient design of heat exchangers, including both condensers and evaporators, aims at lowering the average temperatures between the two fluids circulating on each side of the heat exchange surface. It would be desirable to change the design of a condenser or evaporator in order to lower the average temperatures between the heat transfer fluids circulating on each side of the heat exchange surface. In addition, when using a refrigerant blend in such a condenser or evaporator, it would be desirable to take advantage of the temperature glide of the refrigerant blend. Such design would be particularly useful for condensers and evaporators used in the mobile air conditioning sector.

### BRIEF SUMMARY OF THE INVENTION

The present invention overcomes the problems of the prior art by using a heat exchanger having dual rows and cross-current refrigerant flow and counter-current air flow. With the configuration of the present invention, cold air comes in from the front of the heat exchanger, and the front row heats the air so that it is warmer when it reaches the second row of the heat exchanger than it would be if the heat exchanger were a one-row heat exchanger. The result in terms of heat exchange in such heat exchangers, such as condensers or evaporators, is that the hottest refrigerant blend is in contact with the hottest air and the coldest refrigerant blend is in contact with the coldest air, leading to a lower difference between the average refrigerant blend temperature and the average air temperature compared to a pure refrigerant in a one-row heat exchanger. The present invention takes advantage of the glide of temperature during the condensation of the refrigerant blend, which leads to an energy gain.

Thus, with the present invention, it is possible to achieve increased capacity and energy efficiency of a heat exchanger, such as a condenser or evaporator, and generally results in a more efficient system.

Therefore, in accordance with the present invention, there is provided a dual-row heat exchanger,

Therefore, in accordance with the present invention, there is provided a dual-row heat exchanger for exchanging heat in a heat transfer fluid, comprising: an inlet; a first row connected to the inlet, the first row comprising a first pass disposed in fluid communication with the inlet; a second row disposed generally parallel to the first row and spaced therefrom, the second row comprising at least one second pass and an outlet disposed in fluid communication with the second pass; and a conduit connecting the first row to the second row.

Further in accordance with the present invention, there is provided an air-conditioning system for an automobile, comprising: a bumper; a dual-row condenser disposed below the bumper, the dual-row condenser comprising: an inlet, a first row connected to the inlet, the first row comprising a first pass disposed in fluid communication with the inlet, a second row connected to the first row, the second row comprising at least one second pass and an outlet disposed in fluid communication with the second pass; and a conduit connecting the first row to the second row.

Also in accordance with the present invention, there is provided a method for exchanging heat in a heat transfer fluid, comprising: circulating a heat transfer fluid through back row means in a first direction; circulating the heat transfer fluid through conduit means from the back row means to front row means; circulating the heat transfer fluid through front row means in a second direction generally parallel to the first direction; and directing air across the front row means and the back row means in a counter-current manner with respect to the first and second directions.

### BRIEF DESCRIPTION OF THE DRAWINGS

The present invention may be better understood with reference to the following figures, wherein:

FIG. 1 is a temperature/entropy diagram of a refrigerant blend having a temperature glide, according to the prior art.

FIG. 2 is a temperature/entropy diagram for a pure refrigerant.

FIG. 3 is a temperature profile for a pure refrigerant.

FIG. 4 is a temperature profile for a refrigerant blend.

FIG. 5 is a schematic diagram of a single-row condenser of the prior art.

FIG. 6 is a front-end view of the bumper of an automobile, including a known single-row condenser of the prior art.

FIG. 7 is a plan view of the front end of an automobile, including a bumper, a single-row condenser of the prior art, a radiator, a fan and an engine.

FIG. 8 is a perspective view of an evaporator used for pure refrigerants according to the prior art.

FIG. 9 is an evaporator temperature profile for a pure refrigerant.

FIG. 10 is an evaporator temperature profile for a refrigerant blend during evaporation, which shows refrigerant temperature, temperature glide of the refrigerant and air temperature.

FIG. 11 is a schematic diagram of a dual-row condenser of the present invention.

FIG. 12 is plan view of the front end of an automobile, including a bumper, a dual-row condenser of the present invention, a radiator, a fan and an engine.

FIG. 13 is a perspective view of an evaporator used for refrigerant blends according to the present invention.

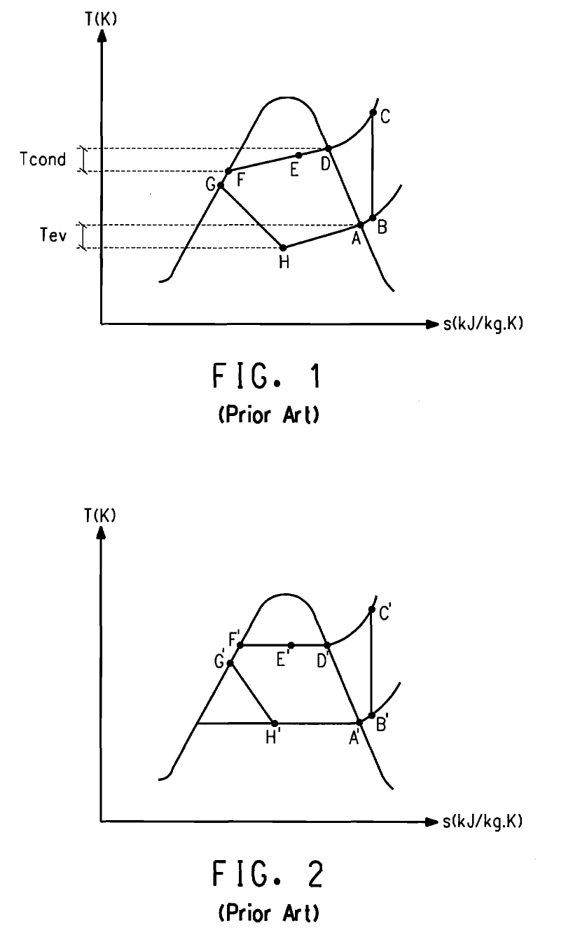

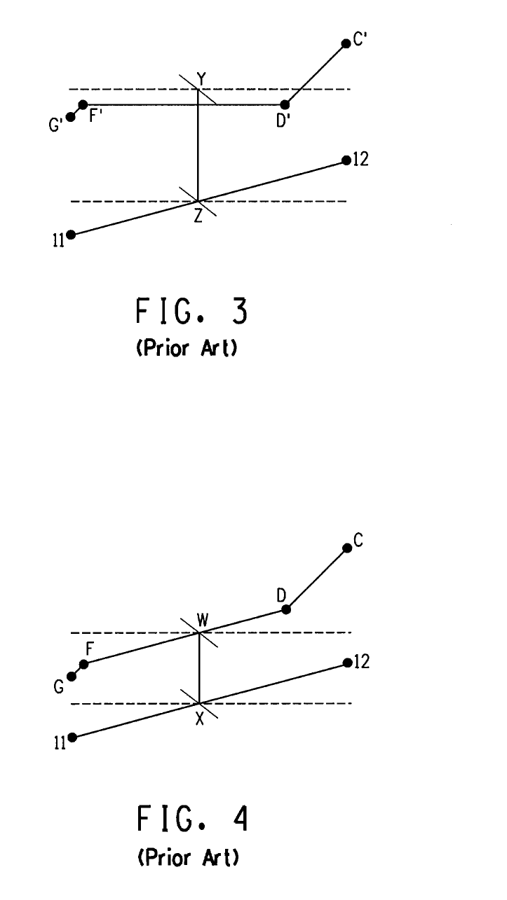

### DETAILED DESCRIPTION OF THE INVENTION

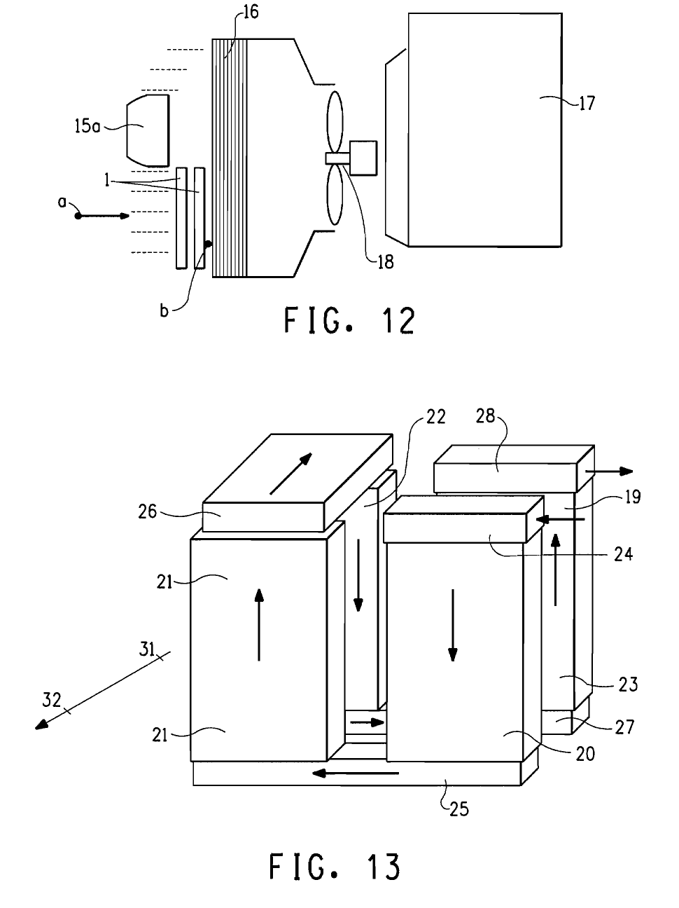

In order to take advantage of the temperature glide of a refrigerant blend, the present invention provides for a dual-row heat exchanger. Such a heat exchanger may be a dual-row condenser, shown in particular in FIG. 11, or a dual-row evaporator, shown in particular in FIG. 13. Refrigerant blends suitable for use in the heat exchangers of the present invention are disclosed in U.S. patent application Ser. No. 11/589,588, filed Oct. 30, 2006, and U.S. patent application Ser. No. 11/486,791, filed Jul. 13, 2006.

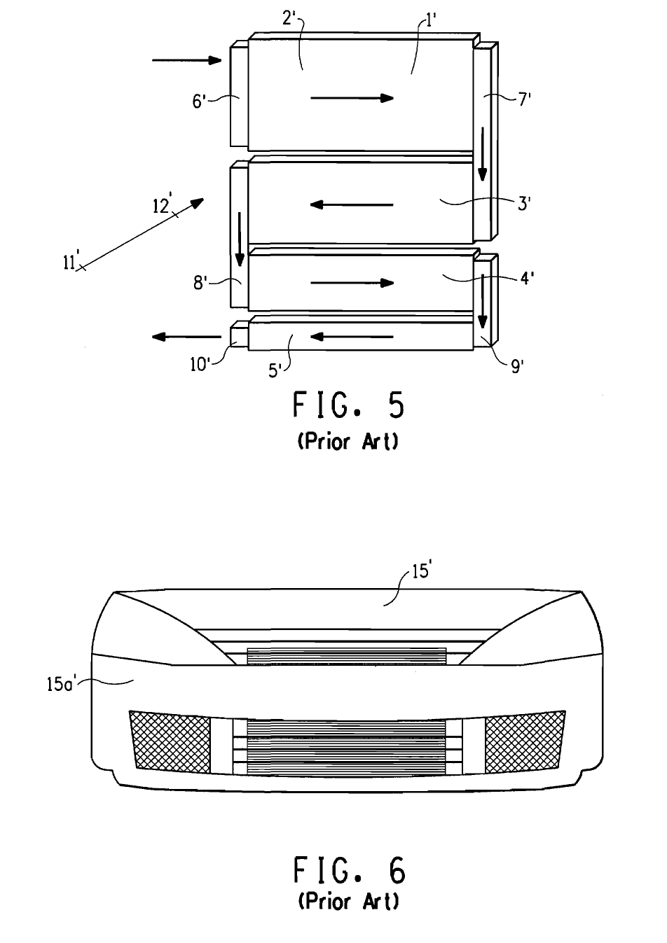

FIG. 11 shows a dual-row condenser 1 according to the present invention that replaces the one-row condenser 1′ as shown in FIG. 5. The dual-row condenser as shown in FIG. 11 is designed in particular for refrigerant blends, and has the same heat exchange surface as the condenser 1′ in FIG. 5, which is designed for pure refrigerants. However, it should be noted that while the dual-row condenser of the present invention is designed to be particularly useful for condensing refrigerant blends, its use is not limited to such heat transfer fluids. Moreover, it should be noted that the design shown in FIG. 11 is generic and can be used for any air-to-refrigerant condenser in stationary applications as well as in mobile applications.

The dual row heat exchanger of the present invention includes front row means for circulating the heat transfer fluid therethrough, back row means for circulating the heat transfer fluid therethrough and conduit means for connecting the front row means and the back row means. The front row means in the dual-row condenser of the present invention may include a front or first row, shown generally at 13. The back row means may include a back or second row, shown generally at 14. The conduit means may comprise a collector, or conduit 7 as shown in FIG. 11. Back row 14 includes an inlet 6 and a pass 2. Front row 13 includes an inlet 15, a first pass or fin tube 3, a first collector, or conduit 8, a second pass or fin tube 4, a second collector or conduit 9, a third pass 5 and an outlet 10. Conduit 7 connects the second, or back row and the first, or front row, specifically, conduit 7 connects the pass 2 of the second row with inlet 15 of the first row. The passes in the front and back row include inlet and outlet manifolds and a plurality of channels disposed therebetween, not shown, as are known in the heat exchanger art, for circulating the heat transfer fluid therethrough.

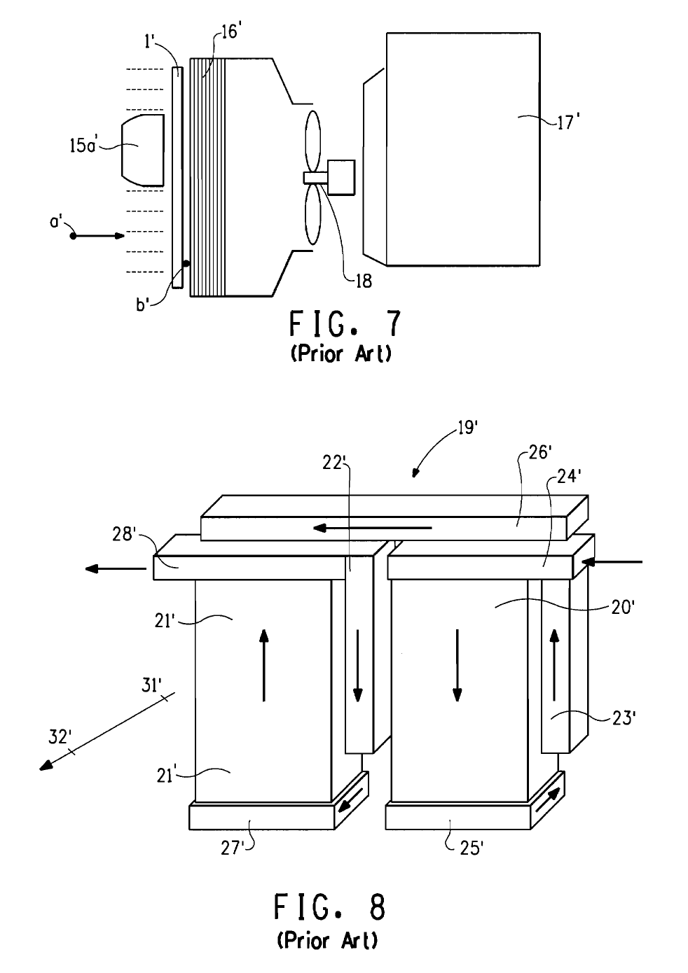

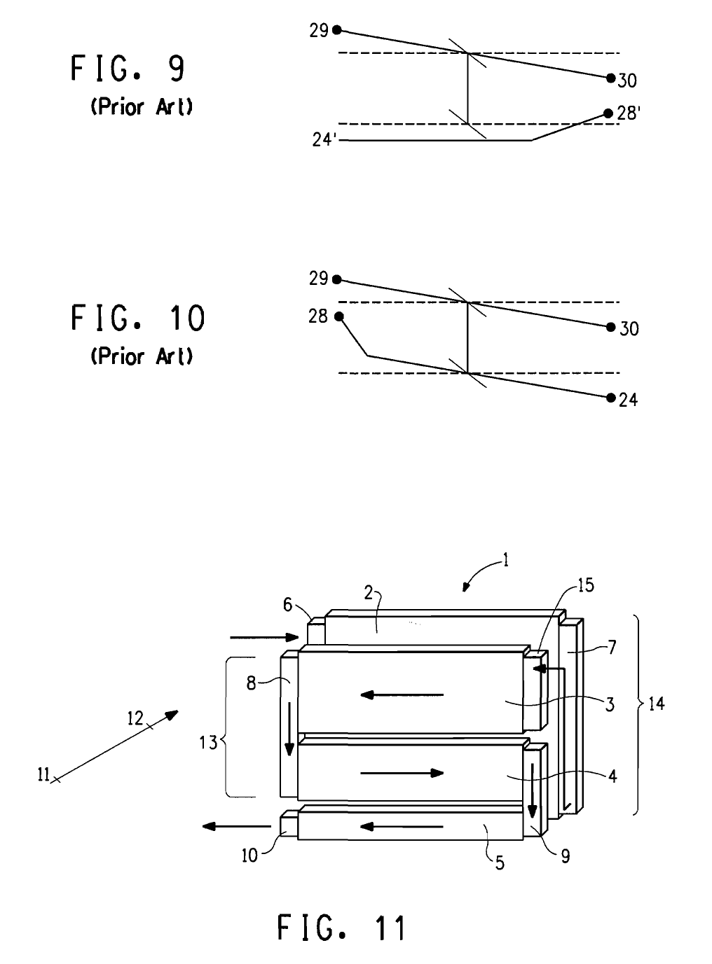

The dual-row condenser of the present invention also include means for directing air across the front row means and the back row means in a counter-current manner with respect to the flow of the heat transfer fluid. The means for directing the air may be a fan, such as fan 18 as shown in FIG. 12, which shows the front end bumper of an automobile, with the two-row condenser of the present invention, which replaces the one-row condenser of the prior art as shown in FIG. 7 in particular. The fan may be installed behind the condenser and the radiator 16. More than one fan may be used. The fans draw the necessary air flow for cooling the condenser and the radiator when the vehicle is idling or when the air flow rate entering the engine compartment is not sufficient. The direction of air flow across the condenser is illustrated by arrow 11-12.

In the design of FIG. 12, the dual-row condenser of the present invention is installed just below the bumper, which is the trapezoidal-shaped piece 15a in front of radiator 16, for cooling engine 17. The top of the condenser of the present invention extends below the bumper so that the bumper does not create any drag on the air flow. In this design, the bumper does not limit the air circulation coming from the outside, as represented by point a, to the inside of the engine compartment after the condenser at point b. The design shown in FIG. 12 shows a significant advantage of in terms of air flow, as compared to the design in FIG. 7. The identical surface area of heat exchange, which is split in the two rows with the dual-row design of the present invention, allows the condenser to be cooled with a high efficiency air flow, which in addition, is no longer hampered by the bumper drag as noted above.

The present invention also provides for a method of exchanging heat in a heat transfer fluid in a dual-row heat exchanger. The method comprises the steps of circulating a heat transfer fluid through back row means in a first direction; circulating the heat transfer fluid through conduit means from the back row means to front row means; circulating the heat transfer fluid through front row means in a second direction generally parallel to the first direction; and directing air across the front row means and the back row means in a counter-current manner with respect to the first and second directions.

This method as it applies to a dual-row condenser, will be described in the context of the description of the operation of the condenser. As shown in FIG. 11, a heat transfer fluid, such as a refrigerant blend, enters the condenser 1 via inlet 6, and is circulated through first pass 2 of the back, or second row. The refrigerant blend is circulated from pass 2 of the second row 14, to the first pass 3 of the first row 13 by conduit 7 and inlet 15 and is then circulated from first pass 3 to second pass 4 in the first row 13 through conduit 8. The refrigerant blend is then circulated from pass 4 to third pass 5 of the first row through conduit 9. Air is blown by fan 18 in the direction as shown in FIG. 11 along arrow a-b in a counter-current manner in reference to the refrigerant flow.

The refrigerant blend is hot when it enters the condenser at inlet 6, and is sub-cooled in second row 14 in a counter-current manner by air, which has been heated by first row 13 of this two-row condenser. The sub-cooled refrigerant blend then exits the condenser 1 via outlet 10. In summary, the air which directed across the dual-row condenser of the present invention is heated in the two successive rows, which is the result of the cross-current/counter-current structure of the heat exchanger. The result, in terms of heat exchange, is that the hottest refrigerant blend is in contact with the hottest air, and the coldest refrigerant blend is in contact with the coldest air, leading to a lower difference between the average refrigerant blend temperature and the average air temperature compared to a pure refrigerant condensed in a one-row condenser.

The concept of developing a cross-current/counter-current heat exchanger for refrigerant-to-air heat exchangers can also be applied to evaporators. For the mobile air conditioning application, one possible design is presented generally at 19 in FIG. 13. However, it should be noted that the design shown in FIG. 11 is generic and can be used for any air-to-refrigerant evaporator in stationary applications as well as in mobile applications. And while the dual-row evaporator of the present invention is designed to be particularly useful for evaporating refrigerant blends, its use is not limited to such heat transfer fluids

The front row means in the dual-row evaporator of the present invention may include a front or first row, shown by passes 20 and 21 in FIG. 13. The back row means in the dual-row evaporator of the present invention may include a back or second row, shown by passes 22 and 23 in FIG. 13. As in the condenser as described above, the passes in the front and back row include inlet and outlet manifolds and a plurality of channels disposed therebetween, not shown, as are known in the heat exchanger art, for circulating the heat transfer fluid therethrough. The conduit means for connecting the back row to the front row may comprise a collector, or conduit 26 as shown in FIG. 13. The front row also includes a collector, or conduit 24 and a collector, or conduit 25 which joins as shown in FIG. 13. The back row also includes a collector or conduit 27, and an outlet conduit 28.

The method of exchanging heat in a heat transfer fluid in a dual-row heat exchanger, as it applies to a dual-row evaporator, will be described with respect to the dual-row evaporator as described above. In operation, the refrigerant blend enters the evaporator through conduit 24. Then the refrigerant flows downwards through tank 20 to tank 21 through collector 25, then from tank 21 to tank 22 through collector 26, then from tank 22 to tank 23 through collector 27, and then exits the evaporator 19 through collector 28. The refrigerant flows from a first row to a second row through a conduit which connects the two rows. The air circulates from 31 to 32 as indicated by the arrow of FIG. 13. In the dual-row evaporator of the present invention, the coldest refrigerant entering in 24 and circulating in tanks 20 and 21 cools the colder air which has been first cooled on the first row of the evaporator. The heater transfer fluid is circulated in the first row in a direction generally counter to the direction of the flow of fluid through the first row.

As illustrated above with respect to FIG. 4, the temperature glide of the refrigerant blend allows lowering the temperature difference ΔT_{w-x}=T_{w}−Tₓ, thus limiting the entropy generation of the heat exchange providing that the air flow and the refrigerant blend flows are organized in a counter-current design. The temperature difference ΔT_{y-z}=T_{y}−T_{z} is calculated similarly to Tₓ and T_{w} using refrigerant enthalpy and entropy on one side and air enthalpy and entropy on the other side. ΔT_{y-z} is larger than ΔT_{w-x} for the same heat exchange surface due to the fact that the condensation D-F shown in FIG. 4 is at a constant temperature and not with glide of temperature. The glide of temperature during the condensation of a refrigerant blend leads to an energy gain if the heat exchanger is designed with the cross-current/counter-current design of the present invention as shown in FIGS. 11 and 13.

### Example 1

A mobile air conditioning apparatus was constructed with a condenser, a compressor, and thermal expansion device. Two types of evaporators were tested, a simple evaporator and an evaporator modified according to the present invention. The air conditioning system was assembled in an environmental chamber and tested at the following conditions: 30° C. ambient temperature, 36 km/hr calculated vehicle speed, 2000 rpm compressor speed, and 380 m³/hr air flow rate on the evaporator. A mixture of 95 weight percent 1,1,1,2,3-pentafluoropropene (HFC-1225ye-Z) and 5 weight percent difluoromethane (HFC-32) with a temperature glide of about 4-5° C. was tested. Cooling capacity (W) and energy efficiency (COP) of the system was measured. Results are shown in Table 1 below.

TABLE 1

| | | | | Delta COP |
|---|---|---|---|---|
| | | Delta Capacity | | Modified/ |
| | Capacity | Modified/Simple | | Simple |
| | (W) | (%) | COP | (%) |
| HFC-1225ye/HFC-32 | 3300 | 9.1% | 1.60 | 11.3% |
| (95/5 wt %) simple | | | | |
| HFC-1225ye/HFC-32 | 3600 | | 1.75 | |
| (95/5 wt %) modified | | | | |

Results show the higher glide refrigerant HFC-1225ye-Z/HFC-32 gains more benefit in cooling capacity and energy efficiency than the pure refrigerant R134a.

### Example 2

A mobile air conditioning apparatus was constructed with an evaporator, compressor, and thermal expansion device. Two types of condensers were tested, a simple condenser and a condenser modified according to the present invention. The air conditioning system was assembled in an environmental chamber and tested at the following conditions: 30° C. ambient temperature, 25 km/hr calculated vehicle speed, 2000 rpm compressor speed, and 250 m³/hr air flow rate on the evaporator. A mixture of 95 weight percent 1,1,1,2,3-pentafluoropropene (HFC-1225ye-Z) and 5 weight percent difluoromethane (HFC-32) with a temperature glide of about 4-5° C. Cooling capacity (W) and energy efficiency (COP) of the system were measured. Results are shown in Table 2 below.

TABLE 2

| | | | | Delta COP |
|---|---|---|---|---|
| | | Delta Capacity | | Modified/ |
| | Capacity | Modified/Simple | | Simple |
| | (W) | (%) | COP | (%) |
| HFC-1225ye/HFC-32 | 2480 | 1.6% | 1.75 | 18.9% |
| (95/5 wt %) simple | | | | |
| HFC-1225ye/HFC-32 | 2520 | | 1.96 | |
| (95/5 wt %) modified | | | | |

Results show that changing the configuration of the condenser to cross-current/counter-current flow, increases cooling capacity and significantly increases energy efficiency.

1. A dual-row heat exchanger for exchanging heat in a heat transfer fluid, comprising:
(a) an inlet;
(b) a first row connected to the inlet, the first row comprising a first pass disposed in fluid communication with the inlet;
(c) a second row disposed generally parallel to the first row and spaced therefrom, the second row comprising at least one second pass and an outlet disposed in fluid communication with the second pass; and
(d) a conduit connecting the first row to the second row.

2. The heat exchanger of claim 1, wherein the heat exchanger is a dual-row condenser.

3. The heat exchanger of claim 1, wherein the heat exchanger is a dual-row evaporator.

4. The heat exchanger of claim 4, wherein the dual-row evaporator comprises:
(i) a front row comprising a first pass and a second pass and a conduit connecting the front row first pass and the second pass,
(ii) a back row comprising a first pass and a second pass and a conduit connecting the back row first pass and second pass, and
(iii) a conduit connecting the second pass of the front row with the first pass of the back row.

5. An air conditioning system, comprising:
(a) a dual-row heat exchanger for exchanging heat in a heat transfer fluid, including:
(i) back row means for circulating a heat transfer fluid therethrough in a first direction;
(ii) front row means for circulating the heat transfer fluid therethrough in a second direction generally parallel to the first direction;
(iii) conduit means for connecting the back row means to the front row means; and
(b) means for directing air across the front row means and the back row means in a counter-current manner with respect to the flow of the heat transfer fluid.

6. The system of claim 5, wherein the front row means comprises at least one pass for circulating the heat transfer fluid therethrough.

7. The system of claim 5, wherein the back row means comprises at least one pass for circulating the heat transfer fluid therethrough.

8. The system of claim 5, wherein the means for directing air comprises a fan.

9. An air-conditioning system for an automobile, comprising:
(a) a bumper;
(b) a dual-row condenser disposed below the bumper, the dual-row condenser comprising:
(i) an inlet,
(ii) a first row connected to the inlet, the first row comprising a first pass disposed in fluid communication with the inlet,
(iii) a second row connected to the first row, the second row comprising at least one second pass and an outlet disposed in fluid communication with the second tube, and
(iv) a conduit connecting the first row to the second pass.

10. (canceled)

11. (canceled)
